(19) United States
(12) Patent Application Publication
(10) Pub. No.: US 2008/0239600 A1
(43) Pub. Date: Oct. 2, 2008

(54) LOW TRIGGER VOLTAGE ESD PROTECTION DEVICE

(75) Inventors: Kang-Neng Hsu, Miaoli (TW); Wen-Chih Li, Miaoli (TW); Chien-Hao Huang, Miaoli (TW); Kun-Huang Chang, Miaoli (TW)

Correspondence Address: WPAT, PC;INTELLECTUAL PROPERTY ATTORNEYS, 2030 MAIN STREET, SUITE 1300, IRVINE, CA, 92614, US

(73) Assignee: INPAQ TECHNOLOGY CO., LTD, Miaoli (TW)

(21) Appl. No.: 11/695,316

(22) Filed: Apr. 2, 2007

(51) Int. Cl. H02H 9/04

(52) U.S. Cl. 361/56

(57) ABSTRACT

The present invention is an electrostatic discharge protection device having a low trigger voltage. The device can utilize a process of manufacturing a PCB to minimize costs and manufacturing time. The device comprises: a discharge area, which is essentially a space within the device and can be filled by a material having a desired breakdown voltage, and at least two electrode areas, wherein the two electrode areas are substantially electrically isolated from each other and simultaneously adjacent to or within the discharge area. When an electric potential difference between the electrode areas exceeds a predetermined value, a conductive path between the electrode areas will be created by discharging through the discharge area. The device is characterized in that each of the two electrodes is a part of a conductive plate, and the two conductive plates become a part of the device by pressing or adhering so that a gap for electric isolation exists between the two electrode areas.

### FIELD OF THE INVENTION

The present invention relates to an electro-static discharge (ESD) protection device, and, more precisely, to an electrostatic discharge protection device with a low trigger voltage and a simple manufacturing process.

### DESCRIPTION OF RELATED ART

Over-voltage protection is a constant subject of discussion in circuitry design. Conventionally, diodes are used in over-voltage protection, but trigger voltages of over-voltage protection devices utilizing diodes typically exceed limits for some integrated circuits, so that their applications are limited.

In relevant fields, some inventions for improving ESD protection devices are already known, e.g. U.S. Pat. No. 6,493,198 assigned to Motorola. The conventional device manufactured in this patent is disposed in a printed circuit board (PCB), and the layer of circuitry is carved by techniques such as etching to produce a suspending and protruding structure so as to direct ESD to the ground layer below by utilizing air as a medium. Although this prior art incorporates the ESD protection device within a PCB so that the manufacturing process is simplified, it still has the following disadvantages:
1. Air is used as the medium so that the trigger voltage is high; however, there is no hint or suggestion that other materials can be used as a medium.
2. It is an open structure, which means that it will be easily covered by undesired layers or contaminated by the environment (thereby lowering its efficiency) in the manufacturing process or in operation respectively, but there is no hint or suggestion in the specification or claims of how to close or protect this structure. On the contrary, an opening has to exist according to the specification.
3. In the prior art, two terminals performing ESD are separated by a dielectric layer, which is usually several mils (one mil= 1/1000 inch) in thickness. This distance is slightly too large for static discharge, but there is no hint or suggestion of how to lower this distance in the specification and claims.

2. To improve these disadvantages above, the present invention proposes an over-voltage ESD protection device with an innovative structure which possesses the advantages of a low trigger voltage and an easier manufacturing process.

### SUMMARY OF THE INVENTION

Similar to all ESD devices, the ESD protection device according to the present invention also comprises two electrode areas substantially isolated from each other. However, the present invention is characterized in that each of the two electrode areas is a part of an conductive plate, and the two conductive plates become a part of the device by pressing or adhering, so that a gap for electric isolation exists between the two electrode areas. Therefore, the present invention is extremely appropriate to be manufactured massively and cheaply by a PCB manufacturing process.

It needs to be pointed out that these conductive plates do not have to be jointed to each other completely, and only the distance of the gap is required to be reserved between the electrode areas.

Further, a discharge area is provided in the ESD protection device of the present invention. The area can be filled up with a material having a required breakdown voltage. The electrode areas are simultaneously adjacent to or within the discharge area. When an electric potential difference between the electrode areas exceeds a predetermined value, a conductive path between the electrode areas will be created by discharging through the discharge area. The material can be a material having a low breakdown voltage such as helium gas or low temperature co-fired ceramic (LTCC) dielectric.

Because the conductive plates of the device of the present invention are pressed or adhered, the distance between the conductive plates (which is the minimum distance between the electrode areas) is only 10˜20 μm (1 μm is 10⁻⁶ meter.) This arrangement is additionally benefited by the discharge area, which is filled up with a material having a low breakdown voltage (helium for example has a breakdown voltage which is 1/9 of that of air), so that theoretically the trigger voltage of the device of the present invention can be as low as 20 volts.

According to the device above, the present invention further provides a method for manufacturing the device, comprising the following steps:

providing two conductive plates, each of which has at least one electrode area;

combining the conductive plates to be at least a part of the device by pressing or adhering, with a gap reserved between the electrode areas for electro-static discharging; and

producing a discharge area filled up with a material having a required breakdown voltage, wherein the electrode areas are simultaneously adjacent to or within the discharge area.

In the device and method above, the gap is substantially smaller than 10 μm. The danger of a short circuit arises if the gap is too small.

If a manufacturing process of a PCB is utilized, the conductive plates can be attached to a substrate as at least a part of the outer layer thereof. The substrate can be a hard plate or soft plate as used in the techniques of PCB manufacture. The hard plate can be a glass fiber plate having an epoxy resin such as FR-4, and the soft plate can be made of polyimide. A heat pressing process can be adopted in the pressing of two conductive plates, and the gap is filled by a layer of adhesive glue.

### BRIEF DESCRIPTION OF THE DRAWING

For the purpose of clear illustration, the following drawings are not drawn 2 0 to the correct scale, so that the ratios in the drawings are for illustration purpose only and do not represent the actual size and ratio in application.

FIG. 1a, FIG. 1b, and FIG. 1c are a top view, a sectional view taken along line A-A′, and a bottom view of an embodiment of the present device.

FIG. 2a, FIG. 2b, and FIG. 2c are a top view, a sectional view taken along line B-B′ of FIG. 2a and a bottom view of a substrate in the manufacturing process of an embodiment of the present invention.

FIG. 3a, FIG. 3b, and FIG. 3c are schematic drawings of a combination of the two substrates in the manufacturing process of an embodiment of the present invention.

### DETAILED DESCRIPTION OF THE INVENTION

For ease of understanding of the present application, an embodiment is provided below to illustrate the present invention, wherein identical reference numerals refer to identical or similar components. This embodiment is only one possible way to practice the present invention. All possible modifications not exceeding the scope of the present invention belong to the scope of claims of the present invention.

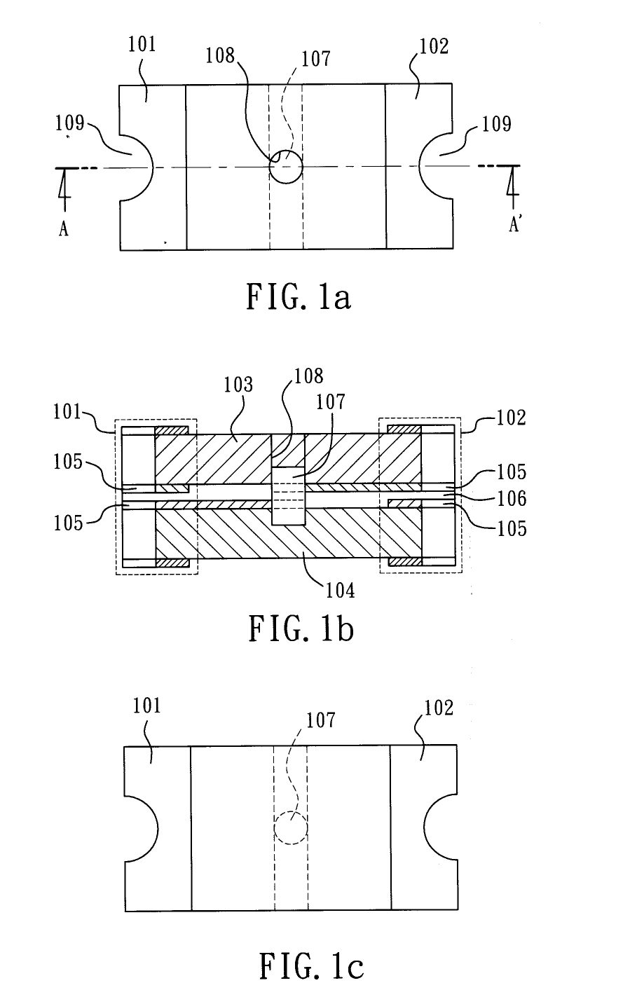

Please refer to FIG. 1a, FIG. 1b and FIG. 1c. FIG. 1a is a top view of a device according to one embodiment of the present invention. FIG. 1b is a sectional view taken along line A-A′ in FIG. 1a of the device. FIG. 1c is the bottom view of the device.

The device of the embodiment comprises at least two external terminals 101 and 102. The device is composed by two substrates 103 and 104. Each of the terminals is shared by both of the substrates. At least one surface of each of the substrates that is connected to the terminals is paved with a conductive plate 105. The conductive plates 105 of the two substrates are combined together, but a gap 106 is reserved at contact surfaces such that the two substrates are not directly electrically connected to each other. The conductive plates 105 do not fully cover the contact surfaces connected to the terminals such that that the terminals of the same substrate substantially do not electrically conduct to each other through the conductive plate 105. The device further comprises a discharge area 107 in the form of a cavity. The discharge area 107 contacts or comprises at least a part of both the conductive plate 105 at the contact surface of each of the substrates, and is filled up with materials having a required breakdown voltage.

In view of the sophisticated structure of the device of the present invention, an introduction to the device will begin at a method of manufacturing the device, such that further understanding of the structure of the device according to the present invention is easier.

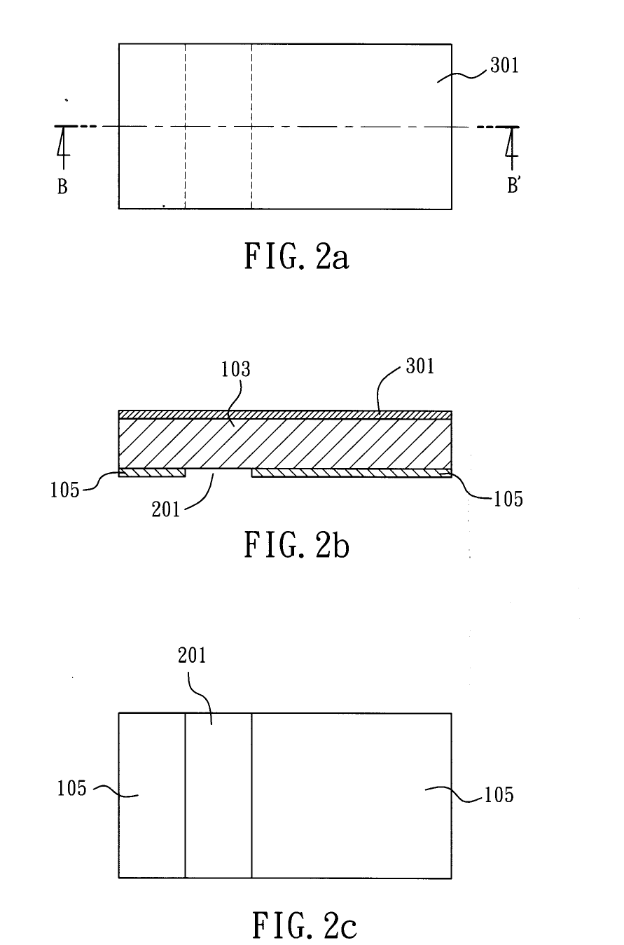

Firstly, two substrates are provided. Illustrated in FIG. 2a, FIG. 2b and FIG. 2c are the top view, sectional view taken along line B-B′ of FIG. 2a and bottom view of the substrate 103 (which is the topmost substrate of FIG. 1b) before being processed, respectively. Another substrate 104 has a similar structure. It is known that each of the substrates comprises a part of both terminals 101,102. Take FIG. 2b for example, the right end thereof is a part of the external terminal 102 of the device, and the left end thereof is a part of the external terminal 101 of the device. At least one surface of each of the substrates that are connected to the terminals 101, 102 is paved with a conductive plate 105.

Then, for each of the substrates, one of the conductive plates is chosen as an adhering surface. In the device of the present invention, the adhering surface is the conductive plate 105. The conductive plate does not fully cover the surface connected to an input terminal and an output terminal, so that the input and output terminals of the same substrate substantially do not electrically conduct to each other through the conductive plate. In FIG. 2b and FIG. 2c, it can be observed that discontinuity 201 of the conductive plate 105 substantially isolates a left end from a right end on the conductive plate 105. A mask is applied on the substrate 103 prior to the conductive plate is adhered to the substrate 103, and the mask is stripped off after the conductive plate is fully adhered to or electrically plated to the substrate 103. Alternatively, we can directly peel off or remove unwanted parts of the conductive plate 105 after the conductive plate is completely adhered to or electrically plated to the substrate without utilizing the mask.

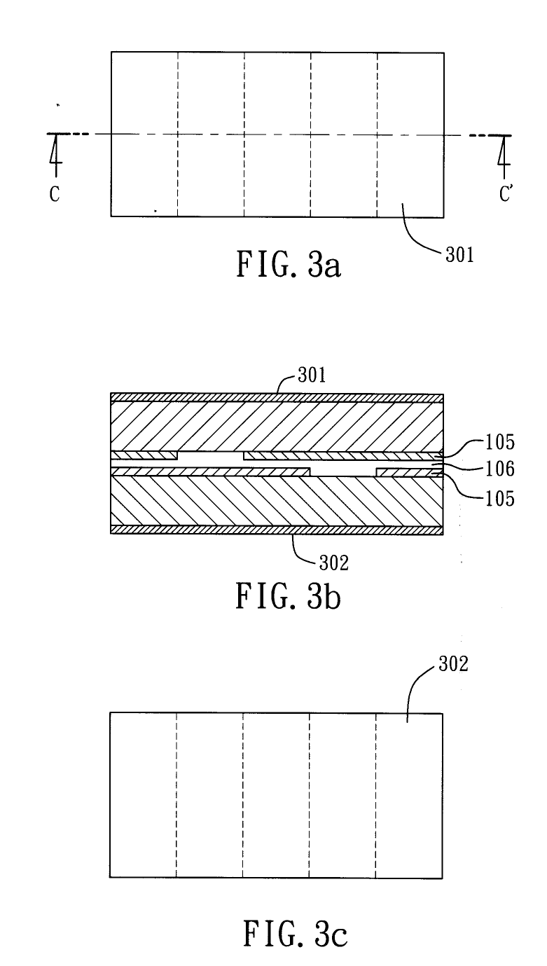

Subsequently, the two substrates are adhered close to each other by the adhering surfaces and a gap 106 is reserved so that the two substrates do not electrically contact each other. FIG. 3a, FIG. 3b and FIG. 3c are the top view, sectional view taken along line C-C′ in FIG. 3a, and bottom view of the device after the substrates are adhered to each other. Then, a discharge area in the form of a cavity is formed between the adhering surfaces of the two substrates, such as the discharge area 107 of FIG. 1b. The discharge area 107 touches or comprises at least a part of the conductive plate 105 of each of both the substrates, and is filled up with a material having a required breakdown voltage. Forming the discharge area in the form of a cavity can be simply done by drilling a hole and then stuffing it by the material with the required breakdown voltage. Then, the discharge area is closed by for example a glass sealant (silicone), to form an area such as the closed area 108 in FIG. 1b.

After the fundamental structure of the device according to the above embodiment is finished, vias 109 can be made at both ends of the substrate. Necessary etching or patterning steps can be done on outer surfaces 301 and 302 in FIG. 3b, and terminal electrodes can be made, so as to make the device into a standard element utilizable on a circuit board, as shown in FIG. 1a, FIG. 1b and FIG. 1c.

Because a PCB manufacturing process is utilized, the device according to the present invention can be massively produced on a single substrate, and the substrate can be finally separated into surface mountable individual ESD over-voltage protection devices. The goal of batch and massive production is obtained thereby. The over-voltage protection devices can also be linked together in parallel to form an array of elements. Besides, the device according to the present invention can be produced on a part (or at a whole) of a PCB, and the PCB becomes a circuit board having the function of ESD protection.

Afterward, many applications are possible but they all are basic modifications of the present invention, and the following are just several examples:
1. LC filtering elements, which cancel high frequency noises and provide the functions of capacitance and inductance, can be attached on an outer surface of the device by surface mount techniques, so as to form a ESD protection device or ESD protection device array by linking a plurality of devices in parallel with the functions of ESD protection and high frequency noise cancellation.
2. LC filtering elements, which cancel high frequency noises and provide the functions of capacitance and inductance, can be attached on an outer surface of the circuit board with the function of ESD protection by surface mount techniques, so as to form a circuit board with both functions of ESD protection and high frequency noise cancellation.
3. circuit board comprising functions of both over-voltage and over-current. If cutting is performed, individual single-chip elements or element arrays having both functions of over-voltage and over-current protections can be produced.
4. The circuit board comprising the functions of both over-voltage and over-current protection can be further provided with LC filtering elements which cancel high frequency noises and provide the functions of capacitance and inductance so as to become a PCB with functions of over-voltage protection, over-current protection, and high frequency noise cancellation. If cutting is performed, individual single-chip elements or element arrays with functions of over-voltage, over-current, and high frequency noise cancellation can be produced.

The gap in the device and method above is substantially larger than 10 μm, and the concern of short circuit arises for smaller gaps.

If the manufacturing process of a PCB is utilized, the conductive plates can be attached to a substrate as at least a part of an outer layer thereof. The substrate can be a hard plate or soft plate as what is used in the techniques of PCB, wherein the hard plate can be a glass fiber plate with epoxy resin similar to FR-4, and the soft plate can be made of polyimide. Heat pressing can be adopted in the pressing of two conductive plates, and the gap is filled by a layer of adhesive glue.

What is claimed is:

1. An ESD protection device, comprising:
a discharge area, which is a space within the device and filled up with a material having a required breakdown voltage;
at least two electrode areas, wherein the electrode areas are isolated from each other and are both adjacent to or within the discharge area, such that the electrode areas will be electrically connected to each other through discharging in the discharge area when an electric potential between the electrode areas is higher than a predetermined value;
characterized in that each of the two electrode areas is a part of each of two conductive plates, the conductive plates are formed as a part of the device by pressing or adhering, and a gap is reserved between the two electrode areas for electrical isolation.

2. The device as claimed in claim 1, wherein each of the conductive plates is attached to a substrate as at least a part of an outer layer of the substrate.

3. The device as claimed in claim 2, wherein the substrates are a hard plate or soft plate used in PCB techniques, the hard plate is a glass fiber plate having epoxy resin such as FR-4, and the soft plate is made of polyimide.

4. The device as claimed in claim 1, wherein the conductive plates are pressed together by a heat pressing process.

5. The device as claimed in claim 4, wherein the conductive plates are pressed together and the gap therebetween is filled by a layer of adhesive glue.

6. The device as claimed in claim 1, wherein the gap is larger than 10 μm.

7. The device as claimed in claim 1, wherein the material is an inert gas or LTCC dielectric.

8. The device as claimed in claim 7, wherein the inert gas is helium.

9. The method of manufacturing an ESD protection device, comprising the following steps:
providing two conductive plates, wherein each of the conductive plate comprises at least one electrode area;
combining the two substrates to form a part of the device by pressing or adhering, and reserving a gap between the electrode areas for ESD protection; and
forming a discharge area filled up with a material with a required breakdown voltage in the device, so that the electrode areas are adjacent to or within the discharge area.

10. The method as claimed in claim 9, wherein the material is an inert gas or LTCC dielectric.

11. The method as claimed in claim 10, wherein the inert gas is helium.

12. The method as claimed in claim 9, wherein the gap is larger than 10 μm.

13. The method as claimed in claim 9, wherein each of the conductive plates can be attached to a substrate as an outer layer thereof.

14. The method as claimed in claim 13, wherein the substrates are hard plates or soft plates used in PCB techniques, wherein the hard plates is a glass fiber plate with epoxy resin such as FR-4, and the soft plate is made of polyimide.

15. The method as claimed in claim 9, wherein the conductive plates are pressed together by a heat pressing process.

16. A method as claimed in claim 15, wherein the conductive plates are pressed together and the gap therebetween is filled by a layer of adhesive glue.

17. An ESD protection device having at least two external terminals, comprising:
two substrates that share each of the external terminals, wherein at least one surface of each of the substrates which is connected to the external terminals is paved with a conductive plate, and the conductive plates of the two substrates are combined at a contact surface, wherein the conductive plates do not fully cover the surface connected to the external terminals so that the external terminals of the same substrate cannot be electrically connected to each other through the conductive plate;
a gap reserved such that the two substrates are not electrically connected to each other; and
a discharge area in the form of a cavity, wherein the discharge area contacts or comprises at least a part of the conductive plate of each of the substrates at the contact surface and is filled up with a material having a required breakdown voltage.

18. The device as claimed in claim 17, wherein the material is an inert gas or LTCC dielectric.

19. The device as claimed in claim 18, wherein the inert gas is helium.

20. The device as claimed in claim 17, wherein the gap is substantially larger than 10 μm.

21. The device as claimed in claim 17, wherein the substrates can be hard plates or soft plates used in PCB techniques, wherein the hard plates are a glass fiber plate having an epoxy resin such as FR-4, and the soft plate is made of polyimide.

22. The device as claimed in claim 17, wherein the substrates are pressed together by a heat pressing process.

23. The device as claimed in claim 22, wherein the gap is filled by a layer of adhesive glue.

24. The method of manufacturing an ESD protection device including at least an output terminal and an input terminal, comprising the following steps:
providing two substrates, wherein each of the substrates comprises a part of the terminals, and at least one surface of each of the substrates which is connected to the terminals is paved with a conductive plate; one of the conductive plates of each of the substrates is chosen as an adhering surface, and the conductive plates do not fully cover the surface which is connected to the terminals so that the terminals of the same substrate are not electrically connected to each other through the conductive plate;
combining the substrates together by using the adhering surface with a gap reserved between the substrates so that the substrates are not directly electrically connected to each other; and
forming a discharge area in the form of a cavity at the adhering surface, wherein the discharge area contacts or comprises at least a part of the conductive plate of each of the substrates and is filled up with a material having a required breakdown voltage.

25. The method as claimed in claim 24, wherein the material is an inert gas or LTCC dielectric.

26. The method as claimed in claim 25, wherein the inert gas is helium.

27. The method as claimed in claim 24, further comprising the steps of: producing the discharge area in the form of a cavity by drilling, and closing the discharge area by a glass sealant after filling the cavity with a material having a required breakdown voltage.

28. The method as claimed in claim 24, wherein the gap is substantially larger than 10 μm.

29. The method as claimed in claim 24, wherein the substrates can be hard plates or soft plates used in PCB techniques, wherein the hard plates are a glass fiber plate having an epoxy resin such as FR-4, and the soft plate is made of polyimide.

30. The method as claimed in claim 24, wherein the conductive plates are pressed together by a heat pressing process.

31. The method as claimed in claim 30, wherein the gap is filled by a layer of adhesive glue.
